(19) United States
(12) Patent Application Publication
(10) Pub. No.: US 2008/0228293 A1
(43) Pub. Date: Sep. 18, 2008

(54) System and method for tuning positioning mechanisms for printing apparatus

(76) Inventors: Rick M. Tanaka, Vancouver, WA (US); Jason Charles Grosse, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/724,949

(22) Filed: Mar. 15, 2007

(51) Int. Cl. G05B 13/00

(52) U.S. Cl. 700/52

(57) ABSTRACT

A method of controlling parameters of a positioning mechanism of a printer comprises calculating a deceleration profile of decaying velocity versus position function by defining the function to represent a specimen motor velocity decay from a maximum velocity to zero velocity over a period during which zero voltage is applied to the specimen motor; and moving a load using the positioning mechanism and the calculated deceleration profile between positions and determining parameter values based on an iterative process.

### FIELD OF THE INVENTION

The invention relates generally to positioning systems and more particularly to methods and apparatus for monitoring and tuning positioning systems.

### BACKGROUND OF THE INVENTION

A media handling subsystem transports a media sheet through a printing apparatus, such as a computer printer, fax machine or copy machine, for imaging. A media sheet is picked from a stack, typically in a tray, then moved along a media path using drive rollers. Printers such as ink-jet printers include at least one print cartridge that contains ink within a reservoir. A carriage holds the print cartridge. The reservoir is connected to a printhead that is mounted to the body of the cartridge. The printhead is controlled for ejecting minute drops of ink from the printhead to a sheet of print media that is advanced through the printer. The carriage is scanned across the width of the paper, and the ejection of the drops onto the paper is controlled to form a swath of an image with each scan. The height of the printed swath (as measured in the direction the media is advanced) is fixed for a particular printhead.

Between carriage scans, the media is advanced so that the next swath of the image may be printed. Inaccurate media advances between scans of the carriage result in print quality artifacts known as banding. The prevention of banding artifacts thus calls for precise control of the advancing media in discrete steps between printed swaths.

The tolerances permitted in media advance and carriage advance are so small that variations in system performance must be considered even within the same printer families, where otherwise identical drive motors and associated media-advance mechanisms are specified. For example, the friction characteristics of media-advance mechanisms (gears, feed rollers, etc.) in one printer will not precisely match those of another, otherwise identical printer. The same is true for the characteristics of the motor that drives the media-advance and carriage advance mechanisms. For convenience, these system frictions and motor characteristics will be hereafter collectively referred to as system response characteristics, which, as noted, vary at least to some degree from printer to printer.

In the past, printer control systems have been designed to account for variations in system response characteristics so that all printers meet the predetermined tolerances. One approach to this is to drive the media advance and carriage position systems conservatively so that acceleration and deceleration rates, as well as maximum velocities, can be achieved by worst-case systems (that is, systems with the poorest system response characteristics). It will be appreciated that this lowest-common-denominator approach inhibits the performance of systems that have average and above-average system response characteristics.

In other approaches, the conservative, worst-case drive approach is reserved for the end of the media advance step. That is, the media is advanced aggressively (rapidly) in a first stage for a majority of the incremental advance distance, but then slowed during a second (“final approach”) stage as the media moves into the proper position. Because of the large position errors that can arise during the first stage, the duration of the second stage is relatively long (despite the fact that the distance moved is small) in order to enable correction of the largest position errors.

U.S. Pat. No. 6,364,551, the subject matter thereof being incorporated herein by reference in its entirety, describes a system and method of controlling a drive motor such as a paper advance motor for carrying out precise and rapid media advance features. The system utilizes a pre-programmed, decaying velocity versus position function that can be considered as an exponentially diminishing curve (deceleration profile). Such deceleration function represents the behavior of a specimen motor (that is, a motor having the same design specifications as the motor used in the printer) as it decelerates following the switch from a full drive voltage to zero voltage. This function is recorded in advance (as by testing at least one, but preferably several, identical motors) in the printer memory. The function may be stored in the form of a look-up table (LUT) or equivalent equation.

As shown in FIG. 3 of U.S. Pat. No. 6,364,551, the controller associates the stored deceleration function with the position of the print media. That is, a zero-velocity point in the function is correlated to a target position of the print media. Thus, at any point along this curve there is a pre-established position error that identifies the distance from the target location. The paper-advance motor is controlled to follow the deceleration curve and will move the print media into its proper target position just as the motor reaches the zero-velocity point in the function. Curved line 44 represents the response of the drive motor as it is driven via application of a first stage constant voltage source. The motor accelerates from an initial velocity to its maximum velocity along curve 44.

When the monitored motor acceleration curve 44 intersects the curve 42 of the deceleration function, the acceleration stage or period is concluded, and the control method shifts to the second, deceleration stage of the method. This stage commences with changing to zero the drive voltage that is applied to the motor. Thereafter, the motor velocity is controlled to follow the deceleration function.

However, due to system response characteristics such as inertia of the system, the transition from the acceleration portion of the curve to the deceleration portion of the curve is not instantaneous but rather includes certain delays.

Alternative systems and methods for monitoring positioning system performance and tuning or calibrating printer positioning and advancement mechanisms taking into account the transition between the acceleration and deceleration curves are desired.

### BRIEF DESCRIPTION OF THE DRAWINGS

Understanding of the present invention will be facilitated by consideration of the following detailed description of the preferred embodiments of the present invention taken in conjunction with the accompanying drawings, in which like numerals refer to like parts and:

FIG. 1 is a schematic front view of a media path and printing apparatus suitable for adaptation to embodiments of the present invention.

FIG. 2 illustrates exemplary performance monitoring process flows according to an embodiment of the present invention.

FIG. 3 is a block diagram of a performance monitor and synchronizing controller coupled to a printer controller and associated components for which the present invention may be adapted.

FIG. 4 illustrates a process flow for controlling parameter values according to an embodiment of the present invention.

FIG. 5 illustrates various deceleration profiles depicting behavior of media-advance drive motors operated at low velocity near stopping position in accord with the present invention.

FIG. 6 shows a more detailed view of a portion of the measured deceleration profile curve of FIG. 5.

FIG. 7 illustrates various curves depicting a variation of motor stopping position past a threshold position as a function of motor response delay parameter in accord with the present invention.

FIG. 8 illustrates a motor stopping accuracy as a function of motor response delay parameter in accord with the present invention.

FIG. 9 illustrates a motor stopping time as a function of motor response delay parameter in accord with the present invention.

### DETAILED DESCRIPTION OF THE PREFERRED EMBODIMENTS

The following description of the preferred embodiments is merely by way of example and is in no way intended to limit the invention, its application, or uses.

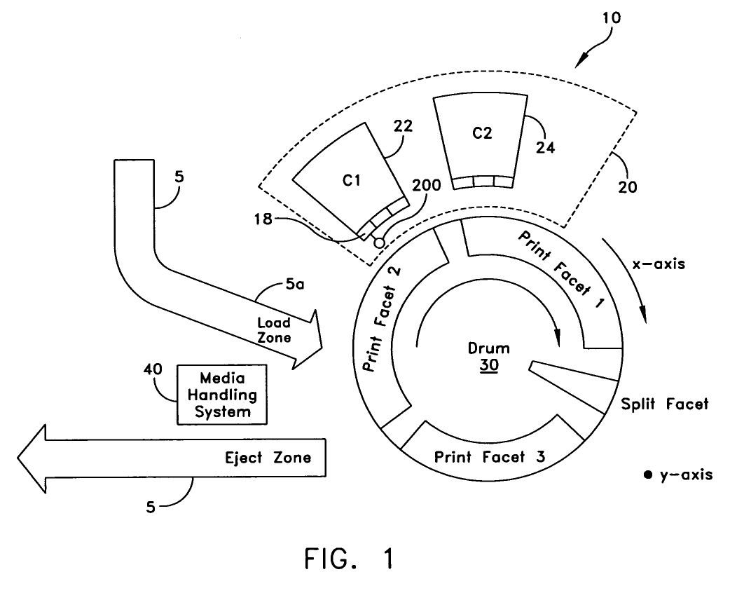

FIG. 1 shows a simplified schematic view of a media path 5 through a printing apparatus 10 according to an embodiment of this invention. Apparatus 10 may take the form of a printer suitable for use with one or more computing devices, a copier, a facsimile machine or a multi-function printing apparatus that incorporates printing/copying/faxing functionalities, all by way of non-limiting example.

Apparatus 10 includes an imaging mechanism 20 for printing images on media sheets while they are supported by drum 30. The media sheets may take the form of sheets of paper, transparencies or any other substrate suitable for having images printed thereon. Mechanism 20 may take the form of a monochrome and/or color printing mechanism, and incorporate one or more print cartridges (such as cartridges that incorporate ink or toner) and/or one or more print carriages 22, 24 that carry one or more printheads or print nozzles, such as ink-jet pen print bodies, all by way of non-limiting example only. Printheads 18 comprise printheads configured to dispense imaging material, such as ink, upon the medium held by drum 30. In one embodiment, printheads 18 comprise piezo electric printheads. In another embodiment, printheads 18 comprise thermal inkjet printheads. As shown by FIG. 1, printheads 18 may be arranged in essentially linear fashion and configured to print across a large area of the media supported by drum 30. In the illustrated embodiment, the imaging mechanism 20 includes two carriages 22, 24 each containing a predetermined number of printheads (e.g. three). Drum 30 rotates and transports media sheets past the movable carriages.

According to an embodiment of the present invention, drum 30 may be suitable for advancing media sheets of different sizes past imaging mechanism 20 in different modes. In such a case, drum 30 may be configured to have a different number of media sheet imaging facets in the different modes. As shown in FIG. 1, drum 30 includes three imaging or printing facets, and is well suited for use where three media sheets may be simultaneously engaged by drum 30. Of course, other drum configurations and numbers of facets may be used. FIG. 1 further illustrates the drum location for a spit facet useful for firing printheads to a spittoon assembly (not shown) in order to maintain ink ejection quality.

Apparatus 10 includes a media handling system 40 that transports media sheets along path 5 to drum 30, and in the illustrated embodiment, receives media sheets from drum 30. The media handling system includes a plurality of drive rollers (not shown), each akin to an elastomeric “tire”. The driver rollers are typically grouped about a rotating shaft (not shown). Each shaft is typically driven by a motor responsively to a media transport controller.

The media handling system picks media sheets from stacks of one or more media sheets supported by input trays. Media sheets picked from the trays are fed along media path 5 through the print apparatus 10 to receive printed markings by imaging mechanism 20.

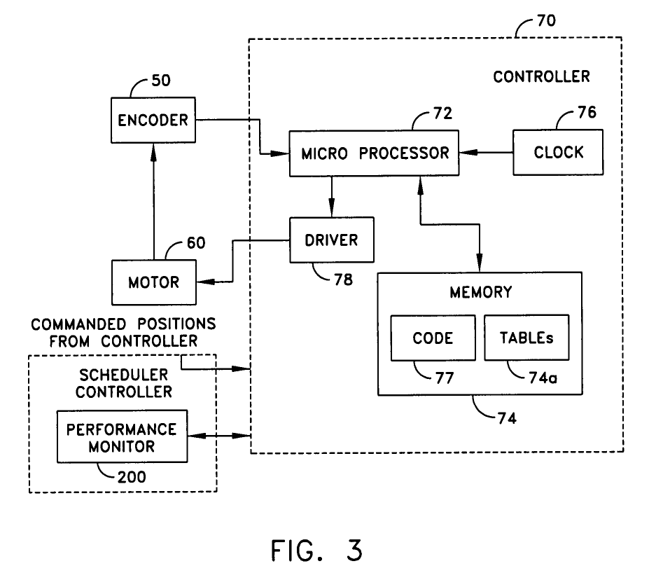

Referring now to FIG. 3 in conjunction with FIG. 1, a rotary encoder 50 is operably coupled to rotatable drum 30 by for example, a shaft that couples drum 30 to a drum motor 60. For non-limiting purposes of explanation only, a rotary encoder may typically take the form of an electromechanical and/or opto-mechanical device used to convert the angular position of a shaft or axle to a digital code. Rotary encoder 50 may take the form of a conventional rotary encoder suitable for providing a signal indicative of the position of drum 30. Controller 70 is adapted to drive drum motor 60 and to read position values from encoder 50 corresponding to the position of drum 30. Rotary encoder 50 may have a position encoding resolution sufficient to allow encoder 50 to provide position indication on the order of 1/7200^{th} inch of drum rotational travel. For example, rotary encoder 50 may have a physical resolution on the order of about 1/150^{th} inch or about 1/300^{th} inch.

Still referring to FIG. 3, controller 70 may typically take the form of a computing device that includes a processor. A processor generally includes a Central Processing Unit (CPU), such as a microprocessor. A CPU generally includes an arithmetic logic unit (ALU), which performs arithmetic and logical operations, and a control unit, which extracts instructions (e.g., code 77) from memory and decodes and executes them, calling on the ALU when necessary. “Memory”, as used herein, generally refers to one or more devices capable of storing data, such as in the form of chips, tapes, disks or drives. Memory may take the form of one or more random-access memory (RAM), read-only memory (ROM), programmable read-only memory (PROM), erasable programmable read-only memory (EPROM), or electrically erasable programmable read-only memory (EEPROM) chips, by way of further example only. Memory may take the form of internal or external disc drives, for example. Memory may be internal or external to an integrated unit including a processor. Memory preferably stores a computer program or code, e.g., a sequence of instructions being operable by a processor. Controller 70 may take the form of hardware, such as an Application Specific Integrated Circuit (ASIC) and or firmware, in addition or in lieu of incorporating a processor.

FIG. 3 shows an exemplary block diagram of controller 70. As seen controller 70 includes a multipurpose microprocessor 72, which, for the purposes of simplicity, is described here in connection with controlling motion of the drum and carriage position. That processor includes associated memory 74 that is pre-programmed to carry out the method of the present invention as explained below. The printer controller 70 is provided with conventional clocking components 76 with which, among other things, operates to correlate printer activities with drum rotation. For example, when a printing task is undertaken and, in particular, when print media needs to be advanced or when carriage movement or positioning is required, the microprocessor provides via motor driver 78 signals that are suitable for driving the corresponding motor. In this regard, the signals may be in the form of a drive voltage placed across the input terminals of the motor. The resulting current rotates the motor shaft and connected gears and positioning assemblies.

In an exemplary embodiment, memory 74 contains or stores at least one table 74a having data entries. According to an embodiment of the present invention, each data entry is indicative of a drum 30 position and at least one associated action, or event. At least some of the actions or events have associated subroutines that may be executed by or at the request of the controller upon occurrence or detection thereof. Such actions, for example, include printhead firing, paper positioning, carriage positioning, and the like. Table 74a may include a separate table for each printing mode, e.g., for different sized media and/or color/monochrome. The microprocessor is apprised by the printer firmware (memory 74) of drum position and motor motion (which is correlated to the various paper advance distance) is monitored by microprocessor 72 via analog, rotary encoder 50 that is associated with the rotating drive shaft of the motor. Suitably conditioned feedback signals are provided to the microprocessor 72 so that, in conjunction with the system clock information, the microprocessor can instantaneously calculate relative positions and adjust print activities in response thereto.

As noted above, positioning mechanisms must be controlled in a manner that provides for proper movement in both time and accuracy. Such movements may be useful to position or advance sheets of media in a precise increment from a first position to a second position along an axis as indicated by the rotation of a drum. In similar fashion, precise positioning or movement of the carriage along a Y axis as indicated by the axis about which the drum rotates may also be required (where the drum is at a constant velocity). Thus, the accuracy and timing associated with movement of a positioning mechanism along an axis (e.g. the paper advance mechanism or the carriage mechanism) should utilize parameters that optimize the system performance.

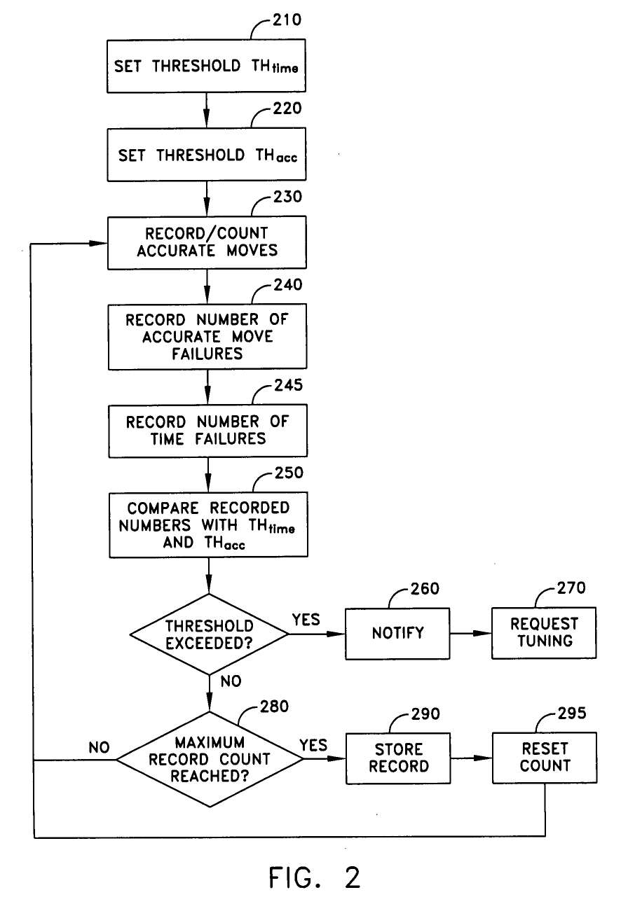

FIG. 2 depicts a block diagram of a printer controller for carrying out embodiments of the present invention. In particular, the printer controller 30 includes a multipurpose microprocessor 32. That processor includes associated memory 34 that is pre-programmed to carry out the method of the present invention as explained below. The printer controller 30 is provided with conventional clocking components 36 with which, among other things, certain velocities may be calculated as described more below.

Whenever a printing task is undertaken and, in particular, whenever a positioning member such as the print media or carriage needs to be advanced by a discrete increment, the microprocessor 32 provides via motor driver 38 signals that are suitable for driving the corresponding driving motor (e.g. drive motor 22). In this regard, the signals may be in the form of a drive voltage placed across the input terminals of the motor. The resulting current rotates the motor shaft and connected gears and feed roller 12.

The microprocessor is apprised by the printer firmware (memory 34) of the distance a positioning member must be advanced as part of the printing process. The motor motion (which is correlated to the paper advance or carriage advance distance) is monitored by microprocessor 32 via an analog, rotary encoder 40 that is associated with the rotating drive shaft of the motor. Suitably conditioned feedback signals are provided to the microprocessor 32 so that, in conjunction with the system clock information, the microprocessor can instantaneously calculate the motor velocity and paper or carriage position.

According to an embodiment of the present invention, an automated method for monitoring and tuning a positioning system utilizes deceleration profiles as described in U.S. Pat. No. 6,364,551 in a manner so as to obtain parameter values that optimize performance characteristics associated with movements of the positioning system.

FIG. 2 illustrates a performance monitoring flow diagram for which performance monitor module 200 is operative in conjunction with the controller 70 and apparatus 10 of FIGS. 1 and 3 for monitoring positioning performance associated with positioning movements along various axes, such as for example, carriage movements and paper advancing movements and corresponding times for carrying out the required movements. Module 200 may be implemented in firmware and operative for executing such processes as part of a controller scheduler and operative with a print sequencer (not shown). In the illustrated embodiment, sequencing and execution of positioning movement actions is controlled by the controller in accordance with drum rotation increments. Thus, the requested movements must occur precisely within both position and time constraints. The performance monitoring according to an aspect of the present invention enables monitoring of accurate requested moves and comparison of those moves that were deemed inaccurate or exceeding a given timing requirement to a threshold value. If either the number of inaccurate moves or the number of moves that took too long exceeds a respective threshold, the positioning system monitor may operate to generate a notification or warning signal and generate a request for performing tuning operations.

Referring now to FIG. 2 in conjunction with FIG. 3, the performance monitoring operations include establishing thresholds for maximum acceptable number of failures in move time THₜᵢₘₑ and accuracy TH_{acc} requirements (blocks 210, 220). For example, the thresholds may be set as X failures per Y moves. As a further example, a threshold accuracy failure rate may be set as 10 inaccurate moves per 10,000 moves; and a threshold time failure rate may be set as 15 slow moves per 10,000 moves.

Performance monitor module 200 receives requested moves that are indicated as being of a category identified as highly accurate and records the total number of moves (block 230), the number of moves that were deemed inaccurate (block 240) (over a threshold value), and the number of moves that took too long to complete (block 245).

In one configuration, when a move request is satisfied the microprocessor (FIG. 3) signals the performance monitor and provides information regarding the move results, including the final position of the move and the time to complete the move. If either the number of inaccurate moves or the number of moves that took too long exceeds a respective threshold (block 250), the monitoring system generates a warning or notification signal (block 260) and requests a tuning action (block 270).

The monitor system may also be configured to maintain a count of the number of moves requested. As shown in block 280, if the count reaches a predetermined threshold (e.g. 10,000 moves), a record of the moves is stored (block 290) for maintaining a history of move performance data and a new set of record counts is initiated (block 295).

In one configuration, the performance monitoring module may be implemented as a continuously running process and may operate to preemptively initiate service and system tuning in advance of significant system performance degradation.

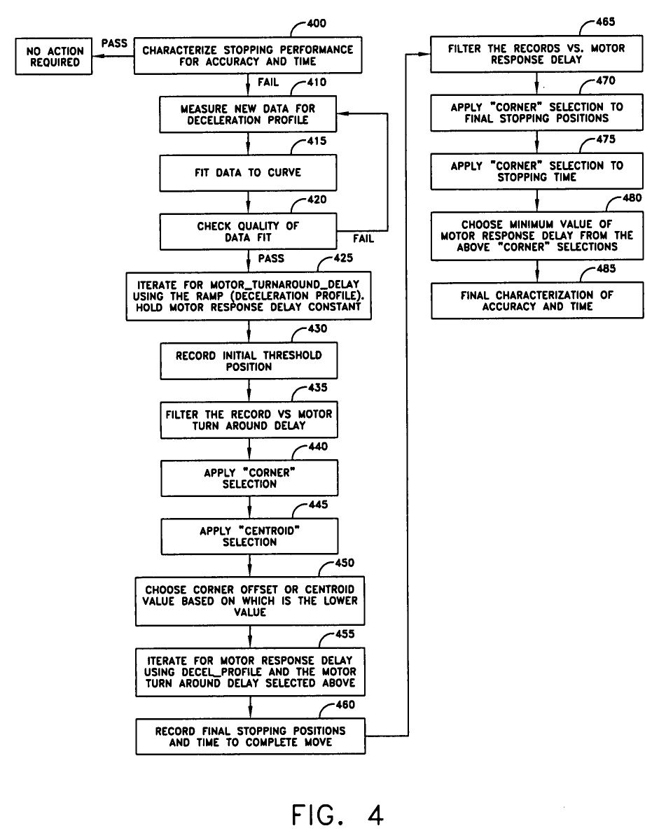

Referring now to the flow diagram of FIG. 4, when a request for tuning is initiated, operations for tuning a printer positioning system for accuracy and move time may be accomplished as follows. The monitoring process may utilize the default deceleration profile parameters that constitute a pre-stored deceleration curve stored in controller memory as described above with regard to U.S. Pat. No. 6,364,551. A load such as a carriage is then moved back and forth under command of the controller and using the default deceleration profile.

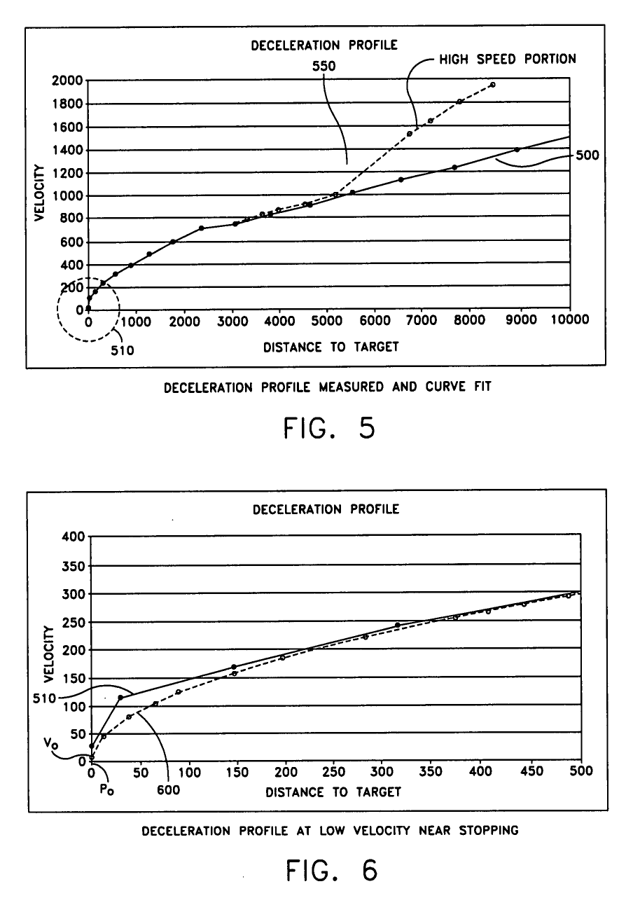

If the number of monitored failures exceeds one of the thresholds, the system operates to obtain new measurement data for the deceleration profile (block 410). This is accomplished, for example, by controlling the motor speed to a predetermined velocity and then removing power to allow the motor to naturally decelerate or coast. The velocity and position of the motor are recorded at sampled data points. In an exemplary embodiment, the recorded positions are relative encoder positions on a rotary encoder operatively coupled to the motor and are sampled and a measured deceleration profile curve 500 (see FIG. 5) is obtained. This provides a distance to target along the X-axis. In one configuration, a predetermined voltage is applied to the motor for a given time duration so as to ramp the motor to a minimum speed and then removed so as to obtain a sufficient amount of measured data of the deceleration profile.

FIG. 6 shows a more detailed view of a portion 510 of the measured deceleration profile curve 500 of FIG. 5. In FIG. 6, curve 510 represents the measured data constituting the deceleration profile at low velocity near the stopping position of the carriage.

Referring again to FIG. 4, operation continues with fitting the raw measured data to a curve (block 415). In one embodiment, the low speed portion of the curve 510 is fit to curve 600 with fixed or known boundary conditions. For example, the curve is fit using a third order polynomial equation and forcing the boundary conditions of zero velocity (V₀=0) at position P₀ and infinite acceleration (a₀=∞) at position P₀. The high speed portion of the measured deceleration profile curve 500 of FIG. 5 may be fit to mate with the low speed fit curve 600 of FIG. 6 as described above, for example, or may simply be coupled to a fixed high speed deceleration curve. A complete fit curve 550 showing both high speed and low speed (510) curve portions is illustrated in FIG. 5. In one configuration, a table of velocity values as a function of target distance representing the fit curve is generated and stored in memory such as a look up table.

The quality of the fit curves is checked (block 420) to ensure sufficient correlation with the measured raw data of curve 500. This may be accomplished, for example, by performing linear regression such as least squares fit on the curve data and comparing with threshold values to determine a sufficient match. If the quality check fails to meet the required threshold match, the processing proceeds to block 410 where new raw data measurements are obtained for generating another deceleration profile curve. Otherwise, the fit curves are used as the commanded deceleration profiles (e.g. velocity vs. distance) for the given axis (e.g. carriage axis) and stored in a memory such as a look up table.

Using the fit profile curve 550 obtained in the preceding step, operation proceeds by scanning through a range of parameter values identified (block 425) as motor turnaround delay parameter. This parameter is a look ahead that determines when to commence deceleration behavior using the stored fit deceleration profile curve 550. That is, due to system response characteristics such as inertia of the system, the transition from motor acceleration to the deceleration portion of the curve is not instantaneous but rather includes certain delays. Such delay is known as motor turnaround delay. The motor turnaround delay parameter value operates to take into account the actual system response and provide a smoother transition from acceleration to deceleration.

An initial value (i.e. starter value) for this motor turnaround delay parameter is obtained for commencing this process, along with all other pertinent parameters such a motor response delay, threshold and the like to given values (i.e. set all values to test initial values).

The motor turnaround delay parameter value is kept constant for a predetermined number N of carriage moves (where N is between 20 and 100, for example). That is, the carriage is moved a target distance (e.g. 0.5 inch) and the position of the carriage recorded on a servo control interrupt after the carriage position crosses a given threshold, is obtained and recorded (block 430). This recording occurs for each set of carriage moves (for a single value of the motor turnaround delay parameter). The motor turnaround delay parameter value is then incremented and another set of carriage moves is carried out with the position of the carriage after it cross the threshold again recorded.

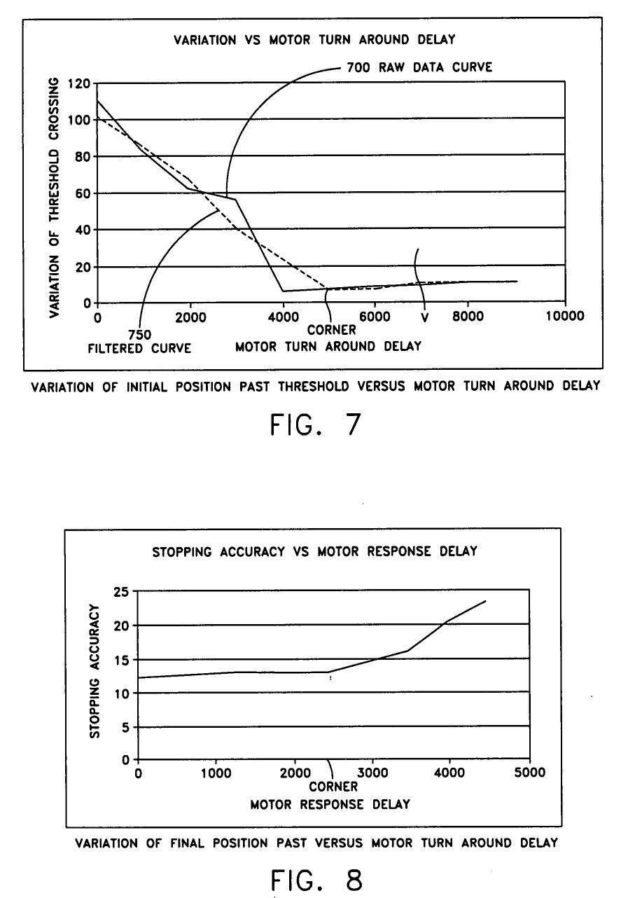

The variation in recorded position of the carriage crossing the threshold is large when the motor turnaround delay parameter value is too small. The variation decreases to a minimum as the parameter value increases, as illustrated by curve 700 in FIG. 7. Note that in certain instances, it is possible that the variation will subsequently increase again as this parameter value continues to be increased.

The recorded data comprising carriage position threshold crossing data and turnaround delay parameter values is then filtered (block 430) to reduce peak values in the data. In one configuration, the filter is a moving average filter that uses the current data point and its preceding and subsequent data point to smooth out the recorded data values. Curve 750 of FIG. 7 shows the filtered curve data.

After the full range of the parameter value has been tested, an optimal value is determined preferably using the filtered curve data. In one configuration, the optimal value is chosen to be a set distance from a “corner” on the performance curve. The corner selection (block 440) of data points is determined by using the variation crossing under a threshold and remaining stable under the threshold (i.e. the rate of change has also reached a low threshold).

Although the corner position can be considered to be a good choice, however, perturbations to the system may result in large changes to the behavior of the positioning system. Therefore, an offset is chosen to separate the choice of the parameter value a sufficient distance away from this corner.

A centroid selection may also be applied (block 440). Here the raw offset is also cross checked against the portion of the parameter vs. variation curve that is fully under the threshold. This is called the centroid check.

Either the corner offset value or the centroid value is selected according to the lower of the two values (block 450). For example, if the centroid of the curve portion that is below the threshold is less than the parameter chosen by the corner offset, the centroid of that curve portion is used as the optimal motor turnaround delay parameter value. This is shown in FIG. 7. The corner is at the value where the curve begins to flatten out at a value of about 5000. In an exemplary embodiment, if an offset of 2000 is used, the optimal value V would be 7000.

The determined optimal motor turnaround delay parameter value is then saved in memory.

Operational flow proceeds to determine an optimal value for the motor response delay parameter (block 455). This parameter governs the behavior of the positioning algorithm as the load decelerates. Using the determined optimized motor turnaround delay parameter value, processing proceeds to perform a set number of carriage moves while keeping the motor response delay parameter value constant; recording for each move the final position of the carriage and the time required to reach the final destination position; and then updating (e.g. incrementing) the motor response delay parameter value and repeating the carriage movement and recordation steps.

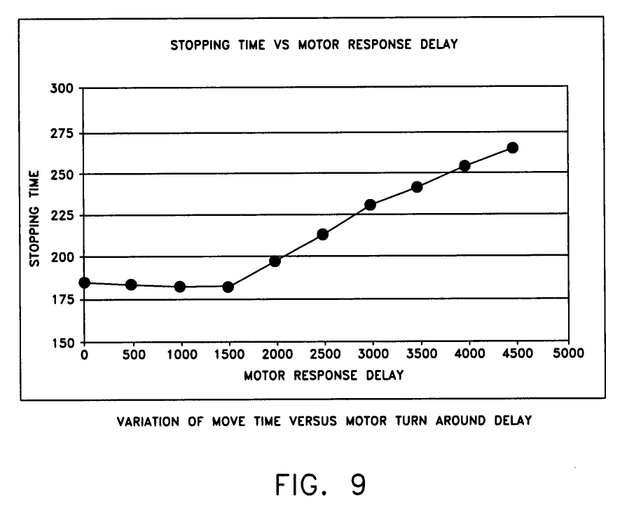

The final stopping position of the carriage and the time that it was required to reach the destination position are recorded (block 460) for each value of the parameter. The variation of the final stopping position and the value+variation of the move time are used to determine the optimal motor response delay parameter value. Typical behavior during these iterations is a decrease in the variation of the final stopping position and an increase in the move time as the value of the motor response delay parameter is increased. FIGS. 8 and 9 are exemplary illustrations of curves depicting the stopping accuracy and stopping time as a function of motor response delay parameter values, respectively. The data is again filtered (block 465) as described above using a weighted average filter, for example.

Corner selection processing is applied to the final stopping position curve data (block 470) as well as to the stopping time curve data (block 475). The optimal value is chosen based on another threshold crossing with a threshold on the rate of change of the stopping position variation. The optimal value is chosen as an offset from this corner to have a known amount of margin. This value is then cross checked against a stopping time performance threshold. The minimum of these two values is chosen (block 480).

Once this optimal motor response delay parameter value is determined, the positioning system may be re-characterized and demonstrated to pass the predetermined tolerance criteria.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of controlling parameters of a positioning mechanism of a printer comprising:
calculating a deceleration profile of decaying velocity versus position function by defining the function to represent a specimen motor velocity decay from a maximum velocity to zero velocity over a period during which zero voltage is applied to the specimen motor;
moving a load using the positioning mechanism and the calculated deceleration profile from a first position to a second position along a first axis a predetermined number of times using a given value of a first parameter and recording a determined position of the load relative to a crossed threshold;
iteratively adjusting the given value of the first parameter a predetermined incremental amount and repeating said moving step over a given range of first parameter values to obtain a curve representing variation in position of threshold crossing as a function of said first parameter value;
using said curve to select an optimal value for said first parameter;
moving said load using the positioning mechanism and the calculated deceleration profile from a first position to a second position along a first axis a predetermined number of times using a given value of a second parameter and using said optimal value of said first parameter and recording a determined stop position of the load and the time required to arrive at said stop position;
iteratively adjusting the given value of the second parameter a predetermined incremental amount and repeating said moving step over a given range of second parameter values to obtain a curve representing stopping accuracy as a function of said second parameter value and a curve representing stopping time as a function of said second parameter value;
using said stopping accuracy curve and said stopping time curve to select an optimal value for said second parameter; and
using said optimal values of said first and second parameters to adjust response characteristics of said positioning mechanism.

2. The method of claim 1, wherein the first parameter comprises a motor turnaround delay.

3. The method of claim 1, wherein the second parameter comprises a motor response delay.

4. The method of claim 1, wherein the step of using said curve to select an optimal value for said first parameter comprises applying at least one of a corner selection and centroid selection to determine an offset value.

5. The method of claim 4, wherein the step of using said curve to select an optimal value for said first parameter comprises applying a corner selection to obtain a first offset value; and applying a centroid selection to determine a second offset value; and selecting the lower of the first and second offset values.

6. The method of claim 1, wherein the step of using said stopping accuracy curve and said stopping time curve to select an optimal value for said second parameter comprises applying at least one of a corner selection and centroid selection to determine an offset value.

7. The method of claim 6, wherein the step of using said stopping accuracy curve and said stopping time curve to select an optimal value for said second parameter comprises applying a corner selection to obtain a first offset value; and applying a centroid selection to determine a second offset value; and selecting the lower of the first and second offset values.

8. The method of claim 1, further comprising
recording a number of requested movements of said positioning system;
recording the number of number of failures in at least one of position and time of said requested movements;
comparing the number of failures to a threshold value; and
providing a notification signal if said threshold value is reached.

9. The method of claim 8, further comprising performing tuning of said positioning mechanism if said threshold value is reached.

10. The method of claim 1, wherein the step of moving said load comprises moving a printer carriage.

11. The method of claim 1, wherein the step of moving said load comprises advancing a sheet of media.
